(19) United States
(12) Patent Application Publication
(10) Pub. No.: US 2014/0290316 A1
(43) Pub. Date: Oct. 2, 2014

(54) ANTI-THEFT DISPLAY HANGER FOR A SOCKET

(71) Applicant: TING-AN CHEN, Taichung City (TW)

(72) Inventor: TING-AN CHEN, Taichung City (TW)

(21) Appl. No.: 13/851,907

(22) Filed: Mar. 27, 2013

(51) Int. Cl. E05B 73/00

(52) U.S. Cl. CPC E05B 73/0017
USPC 70/61

(57) ABSTRACT

An anti-theft display hanger for a socket contains a body including a hanging board and an insertion portion. The insertion portion has two side plates extending outwardly from a bottom end of the hanging board and inserted into a locking hole of a socket such that the two side plates abut against two symmetrical inner walls of the locking hole of the socket, a retainer defined between the two side plates and having a coupling section contacting with the locking hole of the socket. The retainer also has a releasing extension disposed on a top end thereof and exposing outside the socket. The coupling section has a locking projection formed on one side thereof so as to retain with a recess of the locking hole of the socket, and the coupling section has two shafts extending outwardly from two sides thereof and connecting with the two side plates.

### FIELD OF THE INVENTION

The present invention relates to an anti-theft display hanger for a socket which is capable of fixing the socket on an anti-theft display hanger securely.

### BACKGROUND OF THE INVENTION

A conventional display hanger is used to fix and display a single socket, but the socket is removed from the display hanger easily without anti-theft function.

TW patent filing no. 093218871 discloses that a socket fixing structure contains a holder, a receiving member, an insertion member, and a positioning member. When the positioning member pushes the insertion member, the insertion member is inserted into and moves in a groove. Also, a pushing portion of the insertion member pushes au arcuate locking portion of the receiving portion so that retaining projection of the arcuate locking portion retains with a recess of a socket, thereby obtaining an anti-theft function.

However, such a socket fixing structure has to use the insertion member and the positioning member to lock the socket, thus having complicated structure and high production cost.

### SUMMARY OF THE INVENTION

The primary object of the present invention is to provide an anti-theft display hanger for a socket which is capable of fixing the socket on an anti-theft display hanger securely and has an anti-theft function.

To obtain the above objectives, an anti-theft display hanger for a socket provided by the present invention contains: a body including a hanging board and an insertion portion.

The insertion portion has two side plates extending outwardly from a bottom end of the hanging board and inserted into a locking hole of a socket such that the two side plates abut against two symmetrical inner walls of the locking hole of the socket, a retainer defined between the two side plates and having a coupling section contacting with the locking hole of the socket.

The retainer also has a releasing extension disposed on a top end thereof and exposing outside the socket. The coupling section has a locking projection formed on one side thereof so as to retain with a recess of the locking hole of the socket, and the coupling section has two shafts extending outwardly from two sides thereof and connecting with the two side plates.

Thereby, the locking projection engages with the recess of the socket so that the body engages with the socket securely. In addition, when removing the body from the socket, the releasing extension is cut, and the two shafts provides prestress to the two sides of the coupling section so that the locking projection engages with the recess, thereafter the insertion portion is pulled out of the socket such that the two shafts deform so that the locking projection disengages from the recess, thus removing the body from the socket.

Thereby, the body engages with or disengages from the socket by ways of the two shafts and the locking projection.

Besides, the retainer has the releasing extension connecting with the coupling section so as to enhance the anti-theft effect.

### BRIEF DESCRIPTION OF THE DRAWINGS

FIG. 1 is a perspective view showing the exploded components of an anti-theft display hanger for a socket according to a preferred embodiment of the present invention.

FIG. 2 is a perspective view showing the assembly of the anti-theft display hanger for the socket according to the preferred embodiment of the present invention.

FIG. 3 is a perspective view showing the operation of the anti-theft display hanger for the socket according to the preferred embodiment of the present invention.

FIG. 4 is a plan view showing the operation of the anti-theft display hanger for the socket according to the preferred embodiment of the present invention.

FIG. 5 is a cross sectional view taken along line 1-1 of FIG. 4.

FIG. 6 is another plan view showing the operation of the anti-theft display hanger for the socket according to the preferred embodiment of the present invention.

FIG. 7 is a cross sectional view taken along line 2-2 of FIG. 6.

FIG. 8 is another perspective view showing the operation of the anti-theft display hanger for the socket according to the preferred embodiment of the present invention.

### DETAILED DESCRIPTION OF THE PREFERRED EMBODIMENTS

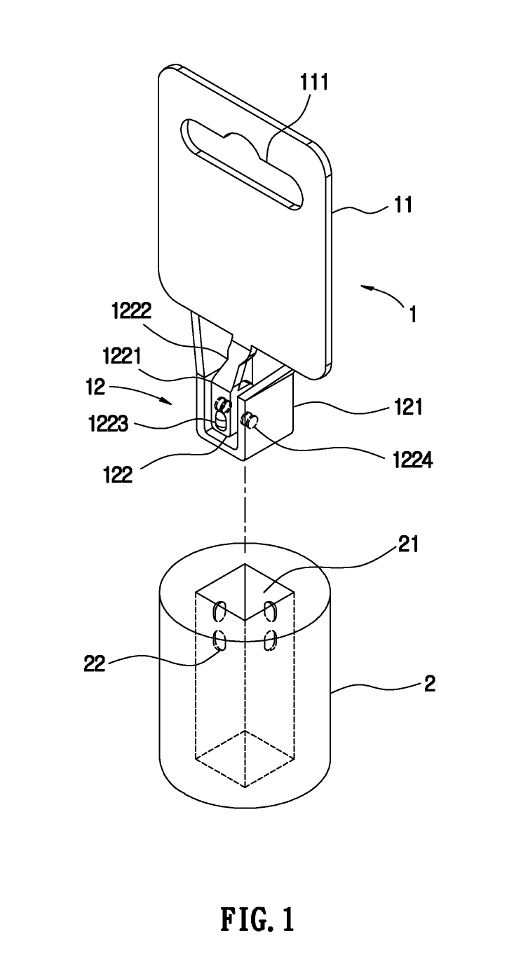

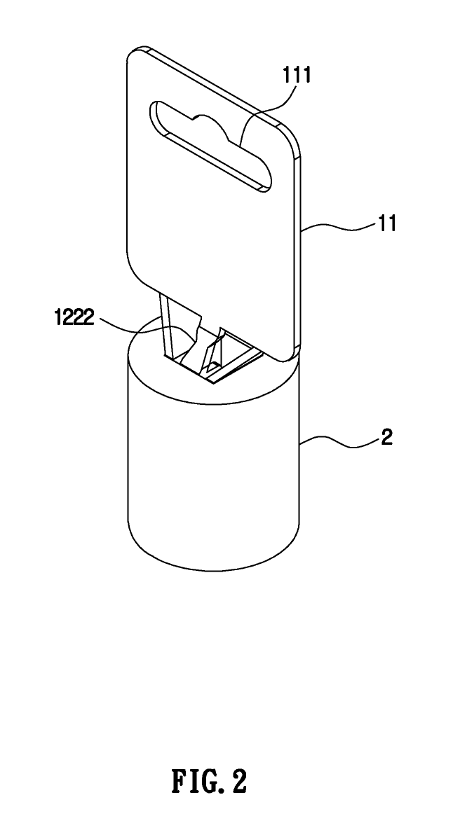

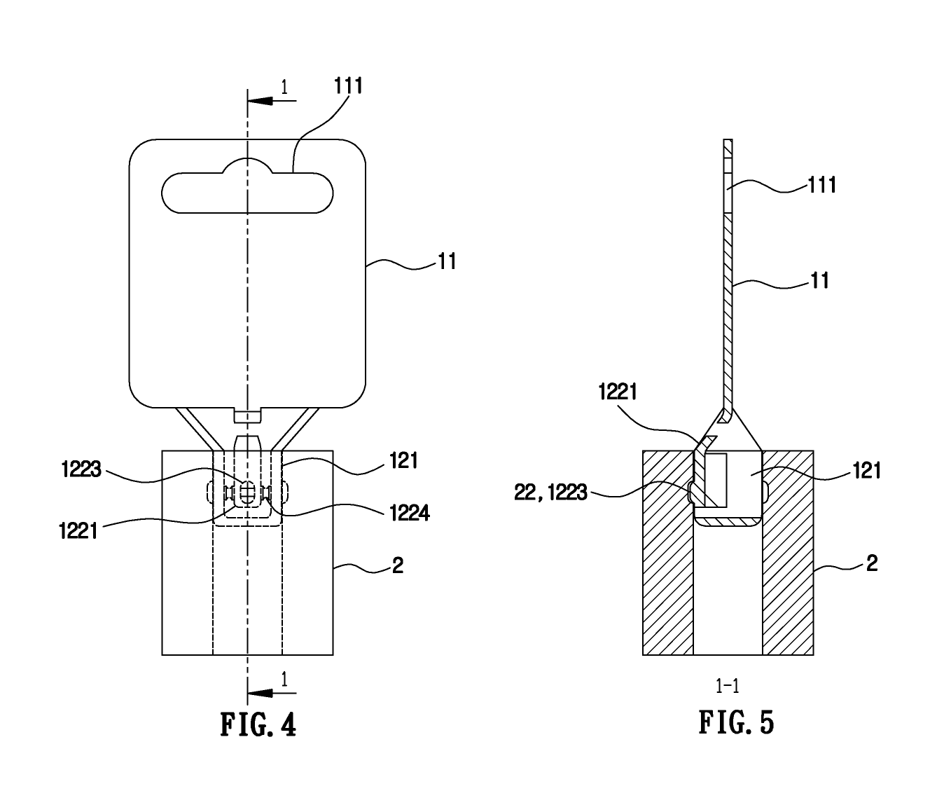

Referring to FIGS. 1-7, an anti-theft display hanger for a socket according to a preferred embodiment of the present invention comprises: a body 1 including a hanging board 11 and an insertion portion 12.

The insertion portion 12 has two side plates 121 extending outwardly from a bottom end of the hanging board 11 so as to be inserted into a locking hole 21 of a socket 2 such that the two side plates 121 abut against two symmetrical inner walls of the locking hole 21 of the socket 2, a retainer 122 defined between the two side plates 121 and having a coupling section 1221 contacting with the locking hole 21 of the socket 2, and the retainer 122 also has a releasing extension 1222 disposed on a top end thereof and exposing outside the socket 2, the coupling section 1221 has a locking projection 1223 formed on one side thereof so as to retain with a recess 22 of the locking hole 21 of the socket 2, and the coupling section 1221 has two shafts 1224 extending outwardly from two sides thereof and connecting with the two side plates 122.

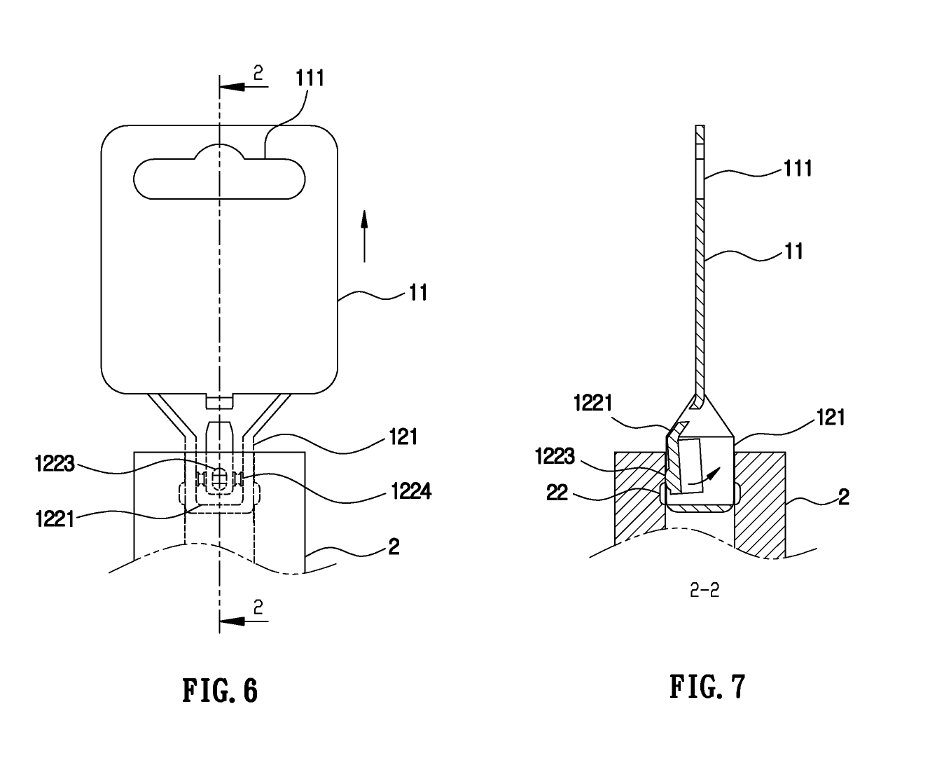

Thereby, the locking projection 1223 engages with the recess 22 of the socket 2 so that the body 1 engages with the socket 2 securely. In addition, when removing the body 1 from the socket 2, the releasing extension 1222 is cut, and the two shafts 1224 provides prestress to the two sides of the coupling section 1221 so that the locking projection 1223 engages with the recess 22, thereafter the insertion portion 12 is pulled out of the socket 2 such that the two shafts 1224 deform so that the locking projection 1223 disengages from the recess 22, thus removing the body 1 from the socket 2 (as shown in FIGS. 6 and 7).

Thereby, the body 1 engages with or disengages from the socket 2 by ways of the two shafts 1224 and the locking projection 1223. Besides, the retainer 122 has the releasing extension 1222 connecting with the coupling section 1221 so as to enhance the anti-theft effect.

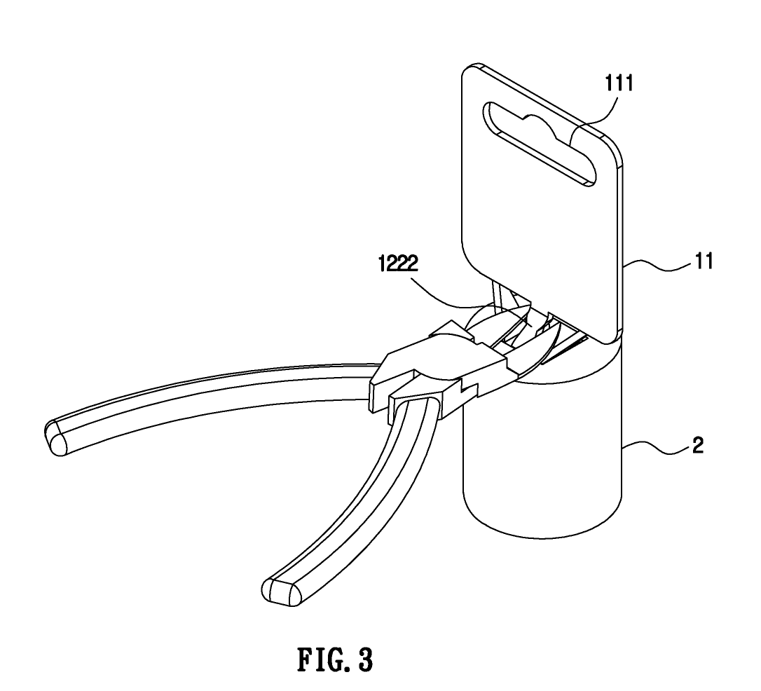

Also, the releasing extension 1222 has a decreased neck formed on a middle section thereof and exposing outsides the socket 2 so as to be cut easily while removing the body 1 from the socket 2 (as illustrated in FIG. 3).

Furthermore, each shaft 1224 has a decreased neck defined on a middle section thereof so as to provide a preferred deformation so that when disengaging the locking projection 1223 from the recess 22, the coupling section 1221 is pushed easily, thus removing the body 1 from the socket 2 quickly.

Also, the hanging board 11 has orifice 111 defined on an upper side thereof so that the anti-theft display hanger is hanged by using the orifice 111 of the hanging board 11.

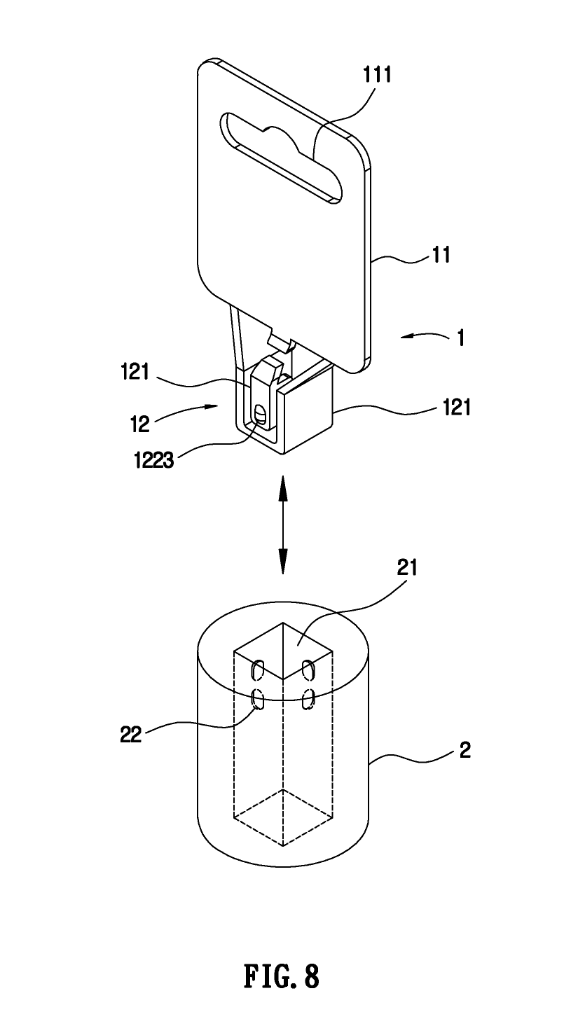

Thereby, when the socket 2 is displayed in a store, it will not be removed from the body 1 since the insertion portion 12 engages with the socket 2. Thereafter, after a user purchases the socket 2, the socket 2 is removed from the body 1 by cutting the releasing extension 1222. At that moment, the locking projection 1223 still engages with the recess 22 so the body 1 is used to store the socket 2 (as shown in FIG. 8).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An anti-theft display hanger for a socket comprising: a body including a hanging board and an insertion portion;
wherein the insertion portion has two side plates extending outwardly from a bottom end of the hanging board so as to be inserted into a locking hole of a socket such that the two side plates abut against two symmetrical inner walls of the locking hole of the socket, a retainer defined between the two side plates and having a coupling section contacting with the locking hole of the socket, and the retainer also has a releasing extension disposed on a top end thereof and exposing outside the socket, the coupling section has a locking projection formed on one side thereof so as to retain with a recess of the locking hole of the socket, and the coupling section has two shafts extending outwardly from two sides thereof and connecting with the two side plates.

2. The anti-theft display hanger for the socket as claimed in claim 1, wherein the releasing extension has a decreased neck formed on a middle section thereof and exposing outsides the socket.

3. The anti-theft display hanger for the socket as claimed in claim 1, wherein each shaft has a decreased neck defined on a middle section thereof.

4. The anti-theft display hanger for the socket as claimed in claim 1, wherein the hanging board has orifice defined on an upper side thereof.
